(19) United States
(12) Patent Application Publication
(10) Pub. No.: US 2026/0056135 A1
(43) Pub. Date: Feb. 26, 2026

(54) Method for operating a container treatment plant, container inspection apparatus for a container treatment plant

(71) Applicant: KRONES AG, Neutraubling (DE)

(72) Inventor: Alexander HEWICKER, Wörth an der Donau (DE)

(21) Appl. No.: 19/307,901

(22) Filed: Aug. 22, 2025

(30) Foreign Application Priority Data
Aug. 22, 2024 (DE) 10 2024 124 077.6

(51) Int. Cl. G01N 21/90; G06V 10/44

(52) U.S. Cl. CPC G01N 21/9081; G06V 10/44

(57) ABSTRACT

A method for operating a container treatment plant for treating a plurality of container parts for containers wherein a transport device transports the plurality of container parts as a container part stream along a predetermined transport path from at least one treatment device of a container treatment plant to at least one further treatment device, wherein at least one sensor device for carrying out a container inspection task captures sensor data, and preferably camera images of the container parts. A deposit variable is determined which is characteristic of a deposit instruction for depositing the captured sensor data on a non-volatile memory device. The deposit variable is determined on the basis of a similarity variable which is characteristic of a similarity between the captured sensor data and predetermined and/or predeterminable reference data.

### CROSS REFERENCE OF RELATED APPLICATIONS

The present application claims benefit to German Patent Application Serial no. 10 2024 124 077.6, filed Aug. 22, 2024, the contents of which are incorporated herein by reference.

### BACKGROUND OF THE INVENTION

The present invention relates to a method for operating a container treatment plant, to a container inspection apparatus for a container treatment plant, and to a container treatment plant.

The containers are preferably plastic containers (in particular PET containers), containers whose main component consists of pulp and/or glass containers and/or cans. The containers may be containers from the beverage and/or food and/or cosmetics and/or pharmaceutical industries. For example, they can be cans or bottles, such as glass bottles, pulp bottles, and plastic bottles.

In container treatment plants, such as container filling plants, a wide variety of sensors and image processing systems are used for process monitoring purposes, for example. For various process steps such as injection molding, container cleaning, filling, labeling, closing, packing, strapping, and/or shrink wrapping, a visual inspection, for example, is subsequently carried out to monitor and/or for controlling or regulating a process.

For each process step, monitoring systems, usually image processing systems, are usually installed, which need configuring and are complex to parameterize. This requires a great deal of experience and sensitivity. For fine adjustment and further improvement, camera images of monitored containers are currently deposited on a permanent image memory.

In current container treatment plants, the strategies for temporary image storage in the camera and permanent image storage on a read-only memory are usually controlled on the basis of different criteria, such as a good/bad rating or recently taken images.

If images with a specific new feature, error, or appearance are to be saved, the aforementioned strategies have the disadvantage that there is no suitable criterion or keep strategy for saving these images. To put it simply, the machine can store only what can be selected using an existing criterion. With approximately 1,000,000,000 images captured daily in a machine, manually selecting and reviewing all the images is out of the question.

DE 10 2021 133 164 B3 discloses a method for carrying out a setting operation of a container inspection apparatus. In this document, a sensor device records spatially resolved sensor data relating to the containers to be inspected, and a real-time evaluation device evaluates the spatially resolved sensor data for the individual inspected containers in real time using an adjustable real-time container inspection model. Furthermore, a plurality of spatially resolved sensor data are provided on a non-volatile memory device. During a setting mode, a setting device retrieves the deposited plurality of spatially resolved sensor data and evaluates a test container inspection model on the basis of the retrieved plurality of spatially resolved sensor data.

The object of the present invention is therefore overcoming the disadvantages known from the prior art and providing a method for operating a container treatment plant, a container inspection apparatus for a container treatment plant, and a container treatment plant, which proposes a deposit strategy for sensor data recorded when inspecting the containers which selects essential sensor data for depositing on a memory device to further improve inspection precision.

### SUMMARY OF THE INVENTION

In a method according to the invention for operating a container treatment plant for treating a plurality of container parts for containers, preferably for plastic containers and/or bottles, a transport device is provided which transports the plurality of container parts (in particular, which are to be treated and/or have been treated) as a container part stream along a predetermined transport path from at least one treatment device of the container treatment plant to at least one further treatment device of the container treatment plant. The container treatment plant preferably comprises the transport device.

The containers are preferably plastic containers (in particular PET containers), containers whose main component consists of pulp and/or glass containers, and/or cans. The containers may be containers from the beverage and/or food and/or cosmetics and/or pharmaceutical industries. For example, they can be cans or bottles, such as glass bottles, pulp bottles, and plastic bottles.

A “container part for a container” can also be understood to mean the container itself. For example, the container part could be a preform from which the fully formed container is produced through a forming process, or it could be the already fully formed container.

The container part for a container can also be a feature of the container, such as a (preferably re-closable) container closure (e.g., a turn-lock fastener or cap), a (PET and/or plastic) lid, a label, a (laser or direct print) marking, a filling material and/or packaging of the (finished) container, a container assembly or the like (as well as combinations thereof).

For example, the transport device can be a supplier (e.g., a supply rail) for container closures, which supplies the container closures from a collecting device to a closing device for closing containers.

Preferably, the container part is an object that can be transported as (precisely one) unit and is transported (independently of further transported container parts) by the transport device.

Preferably, the (first) treatment device and/or the (at least one) further treatment device (in particular each) carries out at least one treatment step on the container part (and preferably on the container).

The treatment step of the (first) treatment device and/or the (at least one) further treatment device can be selected from a group of treatment steps, which include an injection molding process for producing an injection-molded part (e.g., a plastic preform), a cleaning process, a crushing process and/or division process (e.g., as part of a recycling process), a forming process (in particular, (stretch) blow molding), a (laser) marking process, an individualization process (e.g., applying a QR code), a rejection process (in which the container part is rejected from the container part stream in the container treatment plant), a sorting process (in which the container parts are sorted according to type), a filling process, a closing process, an (in particular direct) printing process, a labeling process, laser decorating, a strapping process (of a container part and preferably of a container), a packaging process (in particular, applying primary and/or secondary packaging, e.g., welding several containers as a package and/or as a packaging unit), in particular carrying out shrink wrapping, determining the composition of substances or mixtures of substances, such as the atmosphere and/or air in or on a container part, preferably a container, e.g., by means of a mass spectrometer and/or an odor sensor device and the like, as well as combinations thereof.

Furthermore, at least one sensor device (of the container treatment plant and/or of a container inspection apparatus described in more detail below), for carrying out a container inspection task, captures sensor data, in particular spatially resolved sensor data (preferably camera images) in relation to the container parts (to be inspected and/or transported), preferably when the container treatment plant is in an operating mode.

Preferably, the transport device transports the plurality of container parts (that are to be treated and/or that have been treated) to the sensor device (for inspection thereof in order to fulfill the container inspection task), which sensor device captures sensor data, in particular spatially resolved sensor data, in relation to each of the transported container parts. The sensor device and/or the container inspection apparatus comprising the at least one sensor device (and described in more detail below) can be arranged between the treatment device and the at least one further treatment device.

Preferably, the container part (to be inspected) is imaged at least at regions in the sensor data, preferably the container part region thereof that is observable or visible from at least one observation direction.

It is conceivable that sensor data be captured or collected separately or individually for each container part to be inspected and/or transported to the sensor device (in each case in a separate capturing step of the sensor device).

Exactly one sensor device can be provided which captures the sensor data for the container parts that are required to carry out the container inspection task. However, it is also conceivable that several sensor devices be provided for this purpose, which, for example, capture the sensor data for the container part from several recording directions and/or which, in a multi-lane transport region, capture the container parts transported in different lanes.

The sensor data are preferably spatially resolved sensor data, which in particular image a property to be captured (such as the color value and/or gray scale value and/or brightness value) of a region of the container part. Preferably, the spatially resolved sensor data specify a sensor data curve as a function of at least one spatial and/or geometric coordinate and preferably as a function of at least two spatial and/or geometric coordinates (or are specifiable).

The sensor data can, for example, be a color value and/or gray value and/or brightness value, such as the sensor data captured by a camera.

The sensor data captured by a LiDAR device can be RGB values and/or intensity values, which are captured and deposited for each captured data point together with or depending upon its X, Y, and Z position value.

It is also conceivable that the sensor data be frequency-resolved sensor data.

For example, at least one intensity value can be captured for each sensor data point on the basis of a frequency of the radiation captured by the sensor device, such that the sensor data indicate a sensor value curve as a function of a frequency.

It is also conceivable that the sensor data be spectrometer sensor data, which are preferably generated by a mass spectrometer, which is used, for example, as an odor sensor. It is conceivable that this could be used to analyze the composition of a gas and/or air and/or air mixture, such as an atmosphere in a container, for example. Here, for example, the captured sensor data can indicate an intensity value curve as a function of a mass-to-charge ratio of atoms and molecules in the atmosphere.

Preferably, the sensor data, in particular spatially resolved sensor data, are optically captured. Preferably, the spatially resolved sensor data are camera images.

Preferably, the sensor data relating to the container parts to be inspected are captured during the transport of each of these container parts to be captured at an unchanged, in particular non-reduced, transport speed, i.e., while the container parts are in motion. In other words, the container parts are not slowed down and/or stopped to capture the sensor data. This offers the advantage of high throughput and production speed of the container treatment plant.

In order to optically capture the sensor data, illumination of the container parts, preferably the containers, can be provided, such as incident light and/or transmitted light illumination.

According to the invention, a deposit variable is determined (preferably by a container inspection apparatus) in relation to the captured, in particular spatially resolved, sensor data (in particular in a computer-implemented method step), which is characteristic of a deposit instruction for depositing the captured, in particular spatially resolved, sensor data on an (at least one) non-volatile memory device.

The deposit variable is preferably a binary variable, wherein the one acceptable value for the deposit variable preferably indicates that the captured, in particular spatially resolved, sensor data are to be deposited on the non-volatile memory device.

Preferably, a further (preferably the second) acceptable deposit variable value indicates that the captured, in particular spatially resolved, sensor data are not to be deposited on the non-volatile memory device. In this case, the captured, in particular spatially resolved, sensor data are thus preferably only temporarily deposited and, for example, deleted from the memory device after a (certain) amount of further captured, in particular spatially resolved, sensor data has been deposited.

Preferably, by allocating/assigning a value of the deposit variable that indicates that the captured sensor data are to be deposited on the non-volatile memory device, depositing these captured sensor data on the non-volatile memory device is initiated and particularly preferably carried out.

The non-volatile memory device may be a memory device which is an (integral) part of the at least one sensor device and/or the container inspection apparatus. It is conceivable that this memory device be a ring memory in which the oldest sensor data are overwritten when the storage capacity is reached (and thus the deposited sensor data are only available for a limited period of time).

The non-volatile memory device may also be a memory device of the container treatment plant which is configured as a read-only memory, for example.

It is conceivable that the captured sensor data be initially deposited (in particular temporarily—preferably, initially, exclusively temporarily) on a memory device of the sensor device.

Preferably, depending upon the (determined) deposit variable, the captured, in particular spatially resolved, sensor data are transmitted from a memory device for merely temporary storage of the captured, in particular spatially resolved, sensor data (for example, the memory device of the sensor device) to a (preferably non-volatile) memory device, in particular for permanent storage of the determined, spatially resolved sensor data (which may, for example, be a read-only memory and/or a memory device external in relation to the sensor device and/or, for example, a memory device of the container inspection apparatus and/or the container treatment plant and/or a memory device external in relation to the container treatment plant).

“Non-volatile” can also mean that the selected images or sensor data and/or the sensor data stored on the non-volatile memory device are only held for a certain period of time, i.e., they are or can be deleted after a settable amount of time or parameterization action (installer). “Non-volatile” can also mean that the images or sensor data do not need to be held or stored after the machine has been switched off.

“Non-volatile” is also intended to mean that the image data to be “held” and/or the sensor data to be deposited must, in the simplest case, be available for parameterization.

It is also conceivable that, in addition or alternatively, with a “non-volatile memory device,” it is understood that the image data to be “held” and/or the sensor data to be deposited are retained even when the memory device is no longer supplied with power.

According to the invention, the deposit variable is determined on the basis of a similarity variable which is characteristic of a similarity between the captured, in particular spatially resolved, sensor data and predetermined and/or predeterminable reference data.

The reference data are preferably deposited in a memory device of the container treatment plant and particularly preferably of the container inspection apparatus, which comprises the sensor device.

In particular, the captured, in particular spatially resolved, sensor data are compared with the reference data, and the similarity variable is determined from the result of the comparison.

Preferably, the similarity variable is a non-discrete variable which, in particular, cannot assume only two or a finite (fixed) number of values. Preferably, the similarity variable is a continuous variable. Preferably, the similarity variable indicates a degree of similarity.

In other words, the machine is extended by a keep strategy or image storage function which, in the case of a sensor device configured as a camera, can store images in the camera and in the rad-only memory on the basis of image similarity. For example, an image of the error or required feature can be used as a reference.

In particular, in the case of a plurality of sensor data, in particular spatially resolved sensor data, the plurality of sensor data can be sorted according to their similarity to the reference data using the similarity variable determined with respect to the predetermined reference data. It is therefore possible to distinguish two or more different captured sensor data in terms of their similarity to the reference data.

Preferably, a (predetermined) plurality of captured, in particular spatially resolved, sensor data are sorted according to the similarity variable determined with respect to the reference data (and preferably with respect to a predetermined plurality of reference data). Preferably, the deposit variable of sensor data of the plurality of captured, in particular spatially resolved, sensor data is determined on the basis of the sequence achieved by these sensor data when sorted.

For example, the five items of sensor data which, in comparison with the remaining sensor data of the plurality of captured, in particular spatially resolved, sensor data, have the highest degree of similarity to the reference data and have reached approximately the top five places when sorted, can be assigned a deposit variable which indicates or is characteristic of the fact that the sensor data are to be deposited on the non-volatile memory device.

This offers the advantage that, for example, a specific error pattern or sensor data relating to a container part type that occur very rarely in the container part stream can be specified as reference data and that a search is automatically carried out within a plurality of captured, in particular spatially resolved, sensor data for those captured sensor data that come closest to this specific error pattern.

In this case, it is possible to specify, e.g., by an operator, how much of the sorted sensor data of the (predetermined) plurality of captured, in particular spatially resolved, sensor data that are to be sorted is to be selected for depositing in the non-volatile memory device (by allocating/assigning a corresponding deposit variable).

The plurality of sensor data to be sorted may be sensor data captured in direct succession.

It is also conceivable that (particularly preferably all of) the plurality of sensor data to be sorted be sensor data, in particular spatially resolved sensor data, captured in a specific, preferably predeterminable (by an operator), period of time. This plurality of sensor data to be sorted can be deposited simultaneously in a memory device.

Preferably, the plurality of sensor data to be sorted are not deposited on a (common) memory device (in particular since the applicant captures an extremely high amount of sensor data daily, thus reaching storage capacities very quickly) at the same time (at least not all of it). It is preferred that, when a predetermined amount of captured sensor data, which are deposited on a memory device, of the plurality of sensor data to be sorted is reached and/or when a predetermined storage requirement therefor is reached, in the case of further sensor data of the plurality of sensor data to be sorted, the similarity value of this further sensor data be determined and, using this determined similarity value, a decision be made as to whether these further sensor data are deposited on the memory device, and instead other sensor data of the plurality of sensor data to be sorted that are already deposited on the memory device are deleted (or whether the further sensor data are not deposited on the memory device and are therefore no longer taken into account as the sorting process continues).

Such a method offers the advantage that, by using the similarity variable, the predetermined amount of captured sensor data of the plurality of sensor data to be sorted that most closely corresponds to the (predetermined) sorting criteria or deposit criteria in the sensor data of the plurality of sensor data to be sorted that have been considered thusfar is always deposited on the memory device.

A further advantage is that this sorting method can be used during continuous working operation. Thus, sorting can gradually begin according to the similarity variable with respect to the reference data as soon as the sensor data have been captured. There is no need to wait until all the sensor data of the plurality of sensor data to be sorted are actually available.

In a preferred method, the reference data are reference sensor data, in particular spatially resolved reference sensor data, that are preferably captured by a sensor device. The sensor device can be the sensor device which captures the sensor data, in particular spatially resolved sensor data (with reference to which the deposit variable is or is to be determined).

Additionally or alternatively, it may be a sensor device that is different (for example, identical in construction) from the sensor device (of the container treatment plant) that captures the sensor data, in particular spatially resolved sensor data.

For example, sensor data collected by a sensor device which is identical in construction in a different container handling plant could be used as reference sensor data. This offers the advantage of being able to check, for example, whether very rarely occurring defects discovered in the different container treatment plant or features resulting from a malfunction in the container treatment plant in the treated container part also occur in the container treatment plant under consideration.

Additionally or alternatively, the reference sensor data may be sensor data, in particular spatially resolved sensor data, that have been captured (by a sensor device) and (preferably automatically) changed manually and/or by image processing methods. For example, sensor data could be changed (especially manually) in such a way that they additionally contain (in particular predetermined) defects. In this way, a check can be made, whether the sensor data captured by the sensor device of the container treatment plant show the same or similar defects.

It is also conceivable that the reference sensor data be generated using an AI-based reference sensor data generation model (machine learning), which has been trained, for example, using a plurality of existing sensor data relating to container parts with a recognized defect type (and using a plurality of existing sensor data relating to defect-free container parts) to generate defective sensor data.

It would also be conceivable that - for example in the case of a new type of container parts to be integrated - data, in particular captured sensor data, which are provided, for example, by a developer of the new type of container parts (for example as a result of a simulation or as sensor data which were captured by a sensor device (of a third party) which is external to the container treatment plant), be used as reference data.

In a further preferred method, the similarity variable is characteristic of a degree of similarity between the captured, in particular spatially resolved, sensor data and a predetermined and/or predeterminable plurality of, in particular spatially resolved, reference sensor data. A similarity variable can therefore also be considered that indicates a similarity to several reference sensor data or is characteristic thereof.

For example, a maximum or minimum similarity variable of all the similarity variables that result in relation to exactly one of the reference sensor data of the plurality of reference sensor data can be selected as the similarity variable that is characteristic of the similarity between the captured, in particular spatially resolved, sensor data and a predetermined and/or predeterminable plurality of, in particular spatially resolved, reference sensor data.

The determination of a similarity variable with respect to a plurality of reference sensor data can be used, for example, to select or deposit those captured sensor data from a plurality of captured sensor data which have the lowest possible similarity to the predetermined reference sensor data (for example to container parts with, in particular, all previously known defects and defect-free container parts) in order to discover, for example, new, previously unknown types of defects.

In a further preferred method, the reference data, preferably the in particular spatially resolved reference sensor data and/or the plurality of, in particular spatially resolved, reference sensor data, are specified by an operator of the container treatment plant, preferably by a human-machine interface of the container treatment plant. This offers the advantage that an operator can select, e.g., by an input device (e.g., configured as a touch display of the container treatment plant), captured sensor data suggested to the operator (e.g., by the inspection apparatus and/or the container treatment device), in particular by displaying them by a display device, as reference sensor data.

However, it is also conceivable that the operator be able to transmit the reference data, on the basis of which the similarity variable is to be determined, via the human-machine interface of the container inspection apparatus and/or the container treatment plant. In this way, reference data can be defined in a user-friendly manner.

In a further preferred method, a rejection variable is determined in relation to the captured, in particular spatially resolved, sensor data, which is characteristic of a rejection instruction to reject the associated container part from the container part stream.

Preferably, the rejection variable is used to determine whether the container part has been rejected from the container part stream. In the case of a corresponding rejection variable that indicates a positive rejection instruction to reject the associated container part from the container part stream, the associated container part is preferably (automatically) rejected from the container part stream by a rejection device of the container treatment plant.

The determination of the rejection variable can be carried out by the container inspection apparatus (in a computer-implemented method step). However, it is also conceivable that a separate, in particular processor-based, rejection-deciding device be provided (in particular as part of the container treatment plant).

In particular, the similarity variable is not a variable that corresponds to the rejection variable, and therefore not all sensor data relating to container parts to be rejected are deposited, for example.

Preferably, the similarity variable is determined independently of the rejection decision made, and/or the rejection variable is not taken into account when determining the similarity variable (and preferably also vice versa).

In particular, the deposit variable is not determined on the basis of one or more determined rejection variables. Therefore, not all sensor data relating to container parts to be rejected and the in each case next following sensor data captured are deposited, but, rather, the deposit variable is determined exclusively on the basis of at least one determined similarity variable or several determined similarity variables.

What is in particular important in the proposed method is that the determination of the deposit variable does not depend exclusively upon whether the container part is to be rejected. In other words, the storage strategy is independent of the rejection criterion selected or specified.

In a further preferred method, sensor data, in particular spatially resolved sensor data, captured for at least one container part that has been rejected and/or is to be rejected are used as reference sensor data. This offers the advantage that captured sensor data similar to these reference sensor data for non-rejected container parts are also captured by such a storage strategy. This makes it possible to check whether the specified rejection criteria are correct or whether they should be further adjusted.

In a further preferred method, a deposit variable characteristic of a positive deposit instruction is determined if a comparatively high degree of similarity between the captured, in particular spatially resolved, sensor data and predetermined and/or predeterminable reference data is and/or will be determined. This can be in particular advantageous for determining (and depositing) types of container parts that rarely occur in the container part stream, for example, or, as described above, sensor data relating to container parts with similar defects or special features.

In a further preferred method, a plurality of reference sensor data are predetermined and a deposit variable characteristic of a positive deposit instruction is determined if a comparatively low degree of similarity between the captured, in particular spatially resolved, sensor data and the predetermined plurality of reference sensor data is and/or will be determined. Compared to the methods known from the prior art, this offers the very advantageous possibility of discovering so-called “blind spots,” i.e., previously undiscovered features or defects in container parts. Since these are not yet known, they have a lower degree of similarity to all the known sensor data that are imaged in the predetermined plurality of reference sensor data. This can be used to further improve or fine-tune treatment processes, for example, or to detect any aging or malfunctions in the container treatment plant, for example.

In a further preferred method, the predetermined plurality of reference sensor data comprise reference sensor data relating both to container parts to be rejected from the container part stream and to container parts that are not to be rejected from the container part stream. This is in particular advantageous if—as described above—previously unknown defects or features on container parts are to be discovered, for example.

In a further preferred method, a set of container part features is predetermined (for the container treatment plant and/or the container inspection apparatus), on the basis of which the similarity variable is determined. Preferably, this set of container part features is deposited on a memory device of the container treatment plant and/or the container inspection apparatus. Preferably, this set of container part features is transmitted to the container treatment plant and/or to the container inspection apparatus (in particular from an external memory device and/or an external server).

Preferably, the set of container part features can be accessed, in particular also the individual container part features of the set of container part features. The set of container part features is therefore not implicitly intrinsically contained in an image evaluation algorithm (as a kind of “black box”), but is deposited in such a way that it can be accessed independently and separately. Particularly preferably, the set of container part features can also be exchanged separately (in particular independently of further software components). It is also conceivable that this set of container part features be able to be output and/or transmitted only on its own.

In a further preferred method, the set of container part features is a set of extracted container part features (in particular by a neural network) automatically obtained as part of a machine learning method carried out in relation to a training container inspection task.

Preferably, the training container inspection task is different from the container inspection task. The container part features are preferably extracted using a machine learning method or by executing a machine learning method that is carried out in relation to a training container inspection task. The purpose of implementing the machine learning method is to obtain a (trained) algorithm or a (trained) model (of machine learning) which serves to fulfill or carry out the training container inspection task.

Preferably, the set of extracted container part features is a set of (extracted) container part features (automatically) extracted as part of the machine learning method carried out in relation to the training container inspection task.

In particular, the extracted container part features are not predetermined features, nor are they a selection of predetermined features (e.g., selected by a user). The extracted container part features are in particular abstract features which indicate or are characteristic of, for example, a light-dark contrast, a variable characteristic of a frequency of straight lines (such as the number of straight lines), the brightness or a brightness curve, contour (line) shapes and/or boundary line shapes, corners, shapes, numbers of corners, curvatures, combinations thereof, or the like.

Preferably, the (in particular all the) container part features are generated automatically (and in particular not selected), preferably as part of the machine learning method.

Preferably, the set of extracted container part features is not adapted and/or changed, even when a container inspection task (which is new and/or additional and/or to be adapted) is set and/or when new/changed reference data or reference sensor data are predetermined.

It is conceivable that a number of the container part features of the set of container part features that have been extracted or are to be extracted will be and/or is predetermined—for example, by a user of the container treatment plant. Preferably, the predetermined number of container part features is taken into account when determining the set of container part features to be extracted. This predetermined number of container part features can be transmitted, e.g., by the user of the container treatment plant, to an external server, which determines the set of container part features to be extracted. However, it is also conceivable that the number of container part features is/will be predetermined by a manufacturer of the container treatment plant and, in particular, cannot be influenced by the container treatment plant (or by an operator thereof).

Using the AI-based similarity metric, the similarity to the reference image or the reference sensor data can be determined. Only similar images or similar captured sensor data are preferably stored and saved.

This offers the advantage that images with a specific feature, error, or appearance can be specifically collected. If the customer complains about a container not being detected, images of similar containers can be specifically collected and used to improve detection.

For example, training images for AI applications can thus be purposefully and efficiently collected.

Preferably, a training data set for training a machine learning detection model for detecting defects and/or types of container parts can be generated on the basis of predetermined reference sensor data and/or a plurality of reference sensor data.

Preferably, the training container inspection task is a different training container inspection task from the container inspection task. The feature extraction, which is complex to train, is, preferably with the aid of a neural network, preferably reused in this way and therefore no longer needs to be adapted. It would also be conceivable, however, for the training container inspection task to be the container inspection task to be carried out.

In a further preferred method, the set of container part features is a set of extracted container part features within the framework of a supervised learning method. Preferably, a set of training data is used to carry out the supervised learning method, which includes sensor data relating to container parts that are labeled or marked with an inspection result of the predetermined training container inspection task to be obtained in each case.

In a further preferred method, the supervised learning method is a K-nearest neighbors algorithm (also abbreviated as “k-NN” or “KNN”). This is, advantageously, a simple algorithm that can be easily adapted to newly added training patterns. The K-nearest neighbors algorithm requires only a k-value and a distance metric, which is not much compared to other machine learning algorithms.

In a further preferred method, a traditional machine learning algorithm is used (as the learning method), such as decision trees (decision tree learning, wherein a decision tree is a non-parametric, supervised learning algorithm preferably with a hierarchical, tree-like structure, which is used, for example, for both classification and regression tasks), random forests or random decision forest, logistic regression, k-means clustering, support vector machines (abbreviation SVM).

In a further preferred method, a feature space is or will be spanned by the set of extracted container part features provided. In other words, a feature space can be formed which is spanned by the set of extracted container part features provided.

Preferably, a distance metric with respect to the feature space is provided.

Preferably, the similarity variable is determined using the distance metric. In this case, the sensor data, in particular the spatially resolved sensor data, and/or the reference sensor data are preferably each represented in the feature space (as a feature vector). A distance between these two feature vectors is preferably determined using the distance metric. This distance or a variable characteristic thereof is preferably used as a similarity variable between the captured, in particular spatially resolved, sensor data and the reference sensor data.

The reference data could, for example, already be a representation of (reference) sensor data in the feature space. For example, the reference data could thus already be a feature vector (or be characteristic thereof). (Predetermined) reference data already specified as a feature vector offer the advantage of a significantly smaller data size.

In other words, a distance metric is preferably provided with respect to the feature space, wherein additionally or alternatively a real-time evaluation device uses the distance metric as a measure of the similarity between sensor data, in particular spatially resolved sensor data, of different container parts and preferably different containers and/or as a measure of the similarity between sensor data captured and reference sensor data (for example, also predetermined when specifying the container inspection task).

Preferably (when carrying out the container inspection task), a similarity between captured, in particular spatially resolved, sensor data of one container part and those of another container part (e.g., specified as reference sensor data) is assessed by the distance metric.

Preferably, a feature vector is created for all of the captured (in particular spatially resolved) sensor data, e.g., for each captured camera image, on the basis of the set of extracted container part features. The feature vector can, for example, be a 256-dimensional vector.

Preferably, the feature vector has a maximum of 512 dimensions, preferably a maximum of 256 dimensions, and particularly preferably a maximum of 128 dimensions. Preferably, the feature vector has at least 16, preferably at least 32, preferably at least 64, and particularly preferably at least 128 dimensions. In principle, however, feature vectors with more than 512 dimensions or a feature space with correspondingly higher dimensionality could also be used.

Preferably (in particular also when carrying out the container inspection task, for example), the distance of the feature vector of sensor data captured in relation for a first container part and the feature vector of the sensor data captured in relation for a further container part can be determined by the distance metric.

Preferably, when carrying out the container inspection task, the distance of the feature vector of sensor data captured in relation for a first container part and a feature vector determined with respect to reference sensor data can be determined by the distance metric.

In this way, the distance metric can be used to determine the feature vectors (and thus the corresponding captured sensor data) that were/are most similar to a given feature vector.

Preferably, feature vectors (and thus the correspondingly captured sensor data) are determined with the smallest possible distance from a predetermined feature vector with respect to the predetermined distance metric.

However, it is also conceivable that the feature vector or those feature vectors (and thus the correspondingly captured sensor data) be determined which, with respect to the specified distance metric, have the greatest possible (or the greatest) distance from predetermined feature vectors and/or from the feature vectors of previously captured sensor data (or sensor data captured within a certain period of time) and/or average and/or more frequent feature vectors. In this way, it is possible to identify very rarely occurring sensor data (e.g., with a very rarely occurring defect and/or with a rarely occurring container part type).

The distance metric is preferably used as a similarity measure to assess the similarity between the captured, in particular spatially resolved, sensor data and the reference data, in particular the reference sensor data, in order to determine the similarity variable.

In a further preferred method, a Euclidean metric and/or a cosine similarity is used in the feature space as the distance metric. Cosine similarity (also known as cosine distance) is a measure of the similarity between two vectors, which determines the cosine of the angle between the two vectors. In particular, cosine similarity can be understood as a measure of how strongly two vectors point in the same direction. The cosine similarity between two vectors a and b can be calculated in particular from the standard scalar product of the vectors a and b, divided by the Euclidean norm of a and the Euclidean norm of b, thus: cosine similarity=(a·b)/(∥a∥∥b∥).

A (relatively) small distance between two feature vectors (in the feature space) obtained with the distance metric is preferably regarded as a low degree of similarity between the two sensor data corresponding to the respective feature vectors. Conversely, a (relatively) large distance between two feature vectors (in the feature space) obtained with the distance metric is preferably regarded as a high degree of similarity between the two sensor data corresponding to the respective feature vectors.

In a further preferred method, the container inspection task is a classification task which is selected from a group of classification tasks comprising (preferably binary) classification into defective and/or defect-free container parts and preferably containers (good/bad containers), detection and/or classification of types of defects of the container part and preferably the container, detection and/or classification of different types of container parts and preferably containers (for example, ten different bottle types), detection and/or classification of a contour and/or color of the container part and preferably the container, detection and/or classification of the fault-free and/or faulty execution of at least one treatment step carried out on the inspected container part, in particular by the (first) treatment device, identification of container part types and/or types of defects which occur comparatively rarely in the container part stream (rare in particular means less than 1/1,000), a label check, a fill-level check, a check of a foaming behavior of a liquid in a container, detection of a hairline crack and/or break in the mouth of a container and/or break in a bottom region of the container, detection of foreign particles arranged or located in or on the container part and/or container and the like, as well as combinations thereof.

The working mode is preferably a continuous (production) operating mode of the container inspection apparatus and/or a continuous (production) operating mode of a container treatment plant, such as a container filling plant, which comprises the container inspection apparatus. In particular, the working mode may be a production mode. In particular, the working mode is not a test mode and/or maintenance mode and/or setting mode with a transport speed of the containers or container parts (as they pass through the container inspection apparatus) that is lower than a transport speed during an working mode, for example.

The sensor device is preferably selected from a group comprising an image recording device, such as a camera (preferably a black-and-white and/or color camera), a CMOS sensor (CMOS: abbreviation for complementary metal-oxide-semiconductor), a CCD sensor, a 3-D sensor, an X-ray-based image recording device, an optical element, a thermal imaging camera, a stereo camera, a LiDAR camera, an odor sensor, and/or a (mass) spectrometer and the like, and combinations thereof.

In a preferred embodiment, the transport device transports the containers from a first treatment device to a further (or second) treatment device (and/or is in particular suitable and intended for this purpose).

Preferably, the first and/or the further treatment device is/are selected from a group comprising an injection molding apparatus for producing an injection-molded part (such as a preform), a cleaning apparatus for cleaning the containers and/or container parts, a crushing device for crushing the containers, a filling apparatus for filling the containers, a forming apparatus for forming a plastic preform into a plastic container, in particular a blow molding machine, a closing device for closing the containers, a labeling apparatus, a marking device, a sorting device, a packaging device (for wrapping and/or shrink wrapping), a device for strapping a container part and/or container, a determination device for determining the composition of substances or mixtures of substances, such as the atmosphere and/or air in or on a container part and preferably a container, e.g., a mass spectrometer and/or an odor sensor device, and the like, as well as combinations thereof.

Preferably, the container part stream is an (in particular continuous) stream (on the transport path) of successive or consecutive container parts. For example, the container part stream may be a container stream, specifically a stream of successive or consecutive containers (on the transport path). The container part stream can be guided or transported in a single lane or in multiple lanes (by the transport device) in certain regions, preferably within the entire container inspection apparatus (as a mass flow). At least one sensor device is preferably assigned to each lane of the container part stream and detects each container part of the container part stream in this lane.

The transport device can also be a mass transporter for transporting a plurality of container parts and preferably containers, preferably in several lanes and/or in an unorganized fashion. The transport device can also be a buffer region for buffering, preferably in several lanes and/or in an unorganized fashion, a plurality of container parts and preferably containers.

The container parts and preferably the containers, can be transported or guided (by the transport device) standing up or upright, preferably at least in regions, preferably along the entire transport region.

Preferably, the transport device is suitable and intended for at least partially guiding or transporting the plurality of container parts and preferably containers, preferably along the entire transport region, of container parts and preferably containers, that are under dynamic pressure.

Preferably, the transport device is suitable and intended for transporting and/or guiding (at least within the transport region) at least 1 container part (and preferably at least one container) per hour, preferably at least 5,000 container parts (and preferably containers) per hour (in particular ones to be inspected), preferably at least 20,000 container parts (and preferably containers) per hour (in particular ones to be inspected), preferably at least 100,000 container parts (and preferably containers; in particular to be inspected), preferably at least 140,000 container parts (and preferably containers; in particular to be inspected) and particularly preferably at least 180,000 container parts (and preferably containers; in particular to be inspected), and carries this out during the working mode of the treatment device and/or container treatment plant. Preferably, the transport device is suitable and intended for transporting and/or guiding (at least within the transport region) a maximum of 180,000 (particularly preferably a maximum of 200,000) container parts (and preferably containers) per hour, in particular ones to be inspected, and carries this out during the working mode of the treatment device and/or the container treatment plant and/or the container inspection apparatus.

Preferably, in a single-lane transport region, the transport device is suitable and intended for transporting and/or guiding (at least within the single-lane transport region) at least 100,000 container parts (and preferably containers) per hour and/or up to 180,000 (particularly preferably at most 200,000) container parts (and preferably containers) per hour and carries this out during the working mode of the treatment device and/or the container treatment plant and/or the container inspection apparatus.

The containers may be preforms from which fully formed containers are produced by a forming process and/or which have so far only been produced by a forming step. The containers can also be already fully formed containers which have reached their final shape-for example, through a forming process of a preform (such as an injection-molded part or a molded part).

The containers may be containers that are empty, yet to be filled, and/or recycled and/or refilled. The containers can also be filled containers. Additionally or alternatively, the containers may be closed and/or closable using (in particular precisely) one container closure.

The containers may be disposable containers or reusable containers.

Preferably, the containers are in particular closable (preferably leak-proof) containers for holding liquids and/or flowable substances, such as pasty and/or cream-like and/or gel-like substances, such as those from the food sector, the cosmetics industry, or the pharmaceutical sector.

It is also conceivable that the containers be containers for holding liquids and/or bodies, such as containers for holding contact lenses.

The external memory device is preferably a cloud-based (preferably non-volatile) memory device and/or an external server (including memory device), wherein the memory device is accessed in particular via the Internet (and/or via a public and/or private network, in particular at least sections of which are wired and/or wireless). An external server is in particular an external server, in particular a backend server, in relation to a container inspection apparatus and/or real-time evaluation device and/or setting device.

The external server is, for example, a backend server, in particular of a container inspection apparatus manufacturer or a service provider, which is configured to manage spatially resolved sensor data (in particular from a plurality of sensor devices and/or a plurality of container inspection apparatuses) and/or to carry out machine learning methods for (training) container inspection methods to be carried out and/or to adjust and/or adapt container inspection apparatuses. The functions of the backend or the external server can be carried out in (external) server farms. The (external) server can be a distributed system.

The present invention is further directed to a method, in particular a computer-implemented method, for determining, in particular for extracting features from, a set of container part features for use in a container inspection apparatus intended for carrying out a container inspection task, said method comprising the steps of:
providing a training container inspection task;
providing a training data set comprising a plurality of sensor data relating to a plurality of container parts for containers and each comprising a label indicating an intended result of the training container inspection task;
performing a machine learning method, preferably a supervised one, on the basis of the training data set with regard to the training container inspection task;
extracting the container part features obtained in the machine learning method. Feature extraction can be performed by the machine learning method algorithm as the first processing stage. It represents an advantageous way to significantly improve processing efficiency and reduce the influence of irrelevant information. The feature extraction is learned automatically during the training phase of the machine learning method.

The machine learning method can be carried out by an (in particular deep) neural network, such as a “convolutional neural network” (CNN). These automatically learn, e.g., during the entire training process (e.g., in a computer vision method as a container inspection task), to extract meaningful features such as edges, shapes, and textures from (raw) sensor data.

In this case, the training container inspection task is preferably different from a container inspection task to be fulfilled and/or carried out on the container inspection apparatus. The container part features are preferably extracted using a machine learning method or by performing a machine learning method that is carried out in relation to a training container inspection task. The purpose of implementing the machine learning method is to obtain a (trained) algorithm or a (trained) model (of machine learning) which serves to fulfill or carry out the training container inspection task.

Preferably, the set of extracted container part features is a set of (extracted) container part features (automatically) extracted as part of the machine learning method carried out in relation to the training container inspection task.

The fact that a training container inspection task that is different from the container inspection task can be used offers the advantage that only a single training process or a single machine learning method, namely, the training process or machine learning method carried out as part of the training container inspection task, is sufficient for feature extraction. The extracted container part features obtained here are then used for other container inspection tasks.

For example, the extracted feature vectors of a bottle in a (camera) image can be used in several inspection tasks/classifications.

Example of two inspection tasks/classifications:
1. Do the feature vectors show a brown bottle?
2. Do the feature vectors show a closed bottle?
   Both can be seen in an image and thus also in the extracted feature vector.
   In the first case, the machine learning algorithm, such as kNN, is then “trained” with feature vectors of brown bottles and bottles of other colors. In the second case, with feature vectors of closed and open bottles.
   The features need to be extracted only once from each image.

In a preferred method, the training process or the machine learning method uses training data comprising a plurality of sensor data (of containers), in particular spatially resolved sensor data, captured by the at least one sensor device. This offers the advantage that the training process is already specifically adapted to the container inspection apparatus to be set, and, for example, specific conditions of the specific container inspection apparatus, such as optical properties of the sensor device or specific lighting conditions in the container inspection apparatus, can be taken into account directly.

Preferably, the sensor data, in particular spatially resolved sensor data (captured by the at least one sensor device) intended for use as training data are provided with (container) type and/or classification features (depending upon the classification task—for example, classification of the type of defect). Preferably, the sensor data, in particular the spatially resolved sensor data, together with the (container) type and/or classification features assigned thereto are deposited as a training data set (in particular on the external and/or non-volatile memory device). A plurality of training data sets are preferably generated in this way. The classification features can be the classes of the training container inspection task (or result classes for the container inspection tasks described above). For example, it is possible to classify the in particular spatially resolved sensor data assigned to a container part with the types of defects and the like that occur therein.

Training the networks requires a number of marked and/or classified sensor data (e.g., images) per application of the order of 1,000 to 100,000 (e.g., 10,000 marked and/or classified images per application). This marking and/or classification can be carried out locally or centrally by image processing experts.

It is (additionally or alternatively) preferable that training data (preferably exclusively) in particular spatially resolved sensor data, of containers parts (or data derived therefrom) are used as sensor data, which were captured by a sensor device of (at least) one other, preferably identical, container inspection apparatus (preferably from the same manufacturer). This offers the advantage that a plurality of sensor data can be provided and used even before the container inspection plant is started up.

It is also conceivable that the training data used be spatially resolved sensor data (or data derived therefrom) generated (exclusively or partially) synthetically or generated via augmentation (data augmentation). This offers the advantage, for example, that rarely occurring classes of defect types can be simulated thereby, and the machine learning model can be trained efficiently therewith.

The training or machine learning method is preferably carried out using supervised learning. However, it would also be possible to train the machine learning method by unsupervised learning, reinforcement learning, or stochastic learning.

Preferably, the extracted container part features are provided and/or transmitted to a container inspection apparatus or a real-time evaluation device of a container inspection apparatus (as described above).

Preferably, the method is carried out on a server external to the container treatment plant, and/or the set of extracted container part features is deposited on a memory device external to the container treatment plant. Preferably, the deposited set of extracted container part features (after release) can be retrieved by the operator of the container treatment plant.

In an advantageous method, the number of container part features of the set of container part features to be extracted is predetermined.

The training process or the machine learning method can be carried out locally (in the container inspection apparatus) and/or centrally and/or locally independently and/or on a server external to the container inspection apparatus and/or the container treatment plant.

In an advantageous method, the machine learning method and/or the feature extraction process is/are carried out spatially separate from the container treatment plant, in particular outside the company premises of the container treatment plant.

Preferably, the set of extracted container part features obtained in the proposed method is used in the method for operating a container treatment plant as proposed above, according to a preferred embodiment.

The present invention is further directed to a container inspection apparatus for a container treatment plant for treating a plurality of container parts for containers and preferably for plastic containers and/or bottles. The container inspection apparatus is suitable, intended and/or configured to carry out a container inspection task in the container treatment plant.

Preferably, the container treatment plant comprises a transport device which is suitable and intended for transporting the plurality of container parts as a container part stream along a predetermined transport path from at least one treatment device of the container treatment plant to at least one further treatment device of the container treatment plant.

The container inspection apparatus comprises at least one sensor device which, in order to carry out the container inspection task, is suitable and intended for capturing sensor data, in particular spatially resolved sensor data, and preferably camera images of the container parts, preferably optically.

According to the invention, the container inspection apparatus is suitable and intended for determining a deposit variable with respect to the captured, in particular spatially resolved, sensor data, which is characteristic of a deposit instruction to deposit the captured, in particular spatially resolved, sensor data on a memory device, preferably a non-volatile one. “Non-volatile” can be understood as described above.

The deposit variable is determined on the basis of a similarity variable which is characteristic of a similarity between the captured, in particular spatially resolved, sensor data and predetermined and/or predeterminable reference data.

It is therefore also proposed in the context of the invention that sensor data be deposited in a memory device on the basis of sensor data similarity. In particular, a similarity to the reference sensor data can be determined here too using an AI-based similarity metric as described above (based upon the set of extracted container part features). Preferably, only similar sensor data are stored and saved.

Preferably, the container inspection apparatus is configured, suitable, and/or intended to carry out all the method steps already described above in connection with the determination of the sensor data and/or in connection with the reference data and/or in connection with the determination of the deposit variable and/or similarity variable, either individually or in combination with one another. Conversely, the method may be provided with any of the features described for the container inspection apparatus, either individually or in combination with one another.

The present invention is further directed to a container treatment plant for treating a plurality of container parts for containers, comprising a container inspection apparatus according to a (preferred) embodiment as described above and comprising a treatment device, at least one further treatment device, and a transport device for transporting the container parts from the treatment device to the at least one further treatment device.

The container treatment plant is preferably configured, suitable, and/or intended to carry out the method for operating a container treatment plant as described above as well as all the method steps already described above in connection with the method, either individually or in combination with one another. Furthermore, the container treatment plant and/or the treatment device and/or the at least one further treatment device and/or the transport device can have or be equipped with at least one of the features described above, either individually or in combination with further features.

The present invention is further directed to a computer program or computer program product comprising program means, in particular a program code, which represents or encodes at least some, and preferably all, of the method steps of the method according to the invention and preferably one of the preferred embodiments described and is configured to be executed by a processor device.

The present invention is further directed to a data memory on which at least one embodiment of the computer program according to the invention or a preferred embodiment of the computer program is stored.

The present invention has been described with reference to a container or container parts for containers. The present invention is also transferable to injection-molded parts (molded parts) or more generally to articles to be treated in a treatment plant (such as contact lenses to be manufactured and/or packaged), the treatment progress and/or the properties and/or states (in terms of defects/quality) of which are monitored by at least one sensor device (for capturing in particular spatially resolved sensor data relating to each individual article to be inspected). The applicant reserves the right to also claim related items.

The present invention is further directed to a method for operating an article treatment plant for treating a plurality of molded parts and/or articles, wherein a transport device transports the plurality of molded parts and/or articles as a parts stream along a predetermined transport path from at least one treatment device of the article treatment plant to at least one further treatment device of the article treatment plant.

In this case, at least one sensor device for carrying out an article inspection task captures sensor data, in particular spatially resolved sensor data, and preferably camera images relating of the molded parts and/or articles, preferably optically.

According to the invention, with respect to the captured, in particular spatially resolved, sensor data, a deposit variable is determined which is characteristic of a deposit instruction for depositing the captured, in particular spatially resolved, sensor data on a non-volatile memory device, wherein the deposit variable is determined on the basis of a similarity variable which is characteristic of a similarity between the captured, in particular spatially resolved, sensor data and predetermined and/or predeterminable reference data.

The invention is further directed to an article inspection apparatus for an article treatment plant for treating a plurality of molded parts and/or articles, for carrying out an article inspection task in the article treatment plant, wherein the article treatment plant has a transport device which is suitable and intended for transporting the plurality of molded parts and/or articles as a parts stream along a predetermined transport path from at least one treatment device of the article treatment plant to at least one further treatment device of the article treatment plant.

The article inspection apparatus has at least one sensor device which is suitable and intended for carrying out the article inspection task of capturing sensor data, in particular spatially resolved sensor data, and preferably camera images in respect of the molded parts and/or articles, preferably optically.

According to the invention, the article inspection apparatus is suitable and intended for determining, with respect to the captured, in particular spatially resolved, sensor data, a deposit variable which is characteristic of a deposit instruction for depositing the captured, in particular spatially resolved, sensor data on a non-volatile memory device, wherein the deposit variable is determined on the basis of a similarity variable that is characteristic of a similarity between the captured, in particular spatially resolved, sensor data and predetermined and/or predeterminable reference data.

The further features described above for the container parts are correspondingly analogously applicable to the molded parts and/or articles.

### BRIEF DESCRIPTION OF THE DRAWINGS

Further advantages and embodiments emerge from the accompanying drawing,

in which:

FIG. 1 shows a schematic view of a container treatment plant according to a preferred embodiment of the invention; and

FIG. 2 shows camera images illustrating the method according to a preferred embodiment of the invention.

### DETAILED DESCRIPTION OF THE INVENTION

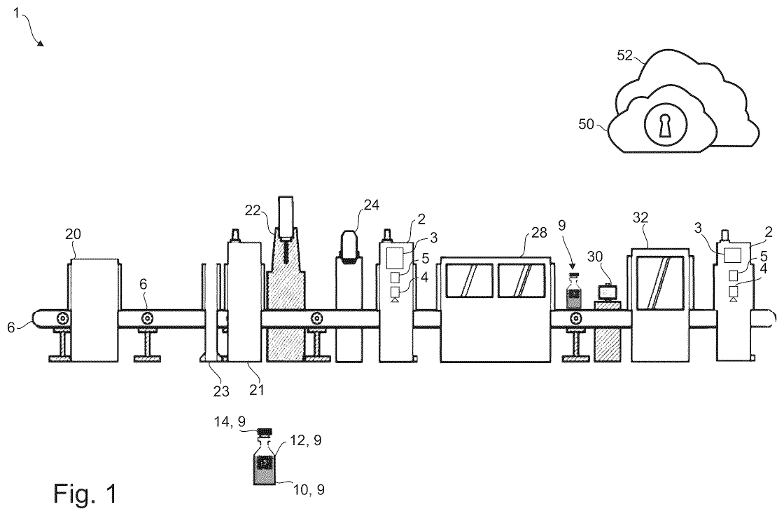

FIG. 1 shows a schematic view of a container treatment plant 1 according to a first embodiment of the invention for treating container parts 10, in this case containers 10 in the form of bottles.

Reference sign 12 denotes a feature arranged on the container part 10, in this case a container. In the exemplary embodiment shown in FIG. 1, an identification means is shown as an example of a feature, which is arranged on the bottle 10. This is, for example, a (printed) QR code. Reference sign 14 designates a container closure as a further feature of the container 10.

In the embodiment shown in FIG. 1, a plastic preform is provided and passed from the transport device 6 to a heating apparatus 20, where it is heated and subsequently expanded in a blow molding apparatus as a further treatment device, the arrangement of which within the container treatment plant 1 is indicated by reference sign 23, to form a (plastic) bottle 10. This bottle 10 can be provided with an identification means 12 by the individualization device, e.g., of a printing device, resulting in a bottle having an identification means 12.

Inside the container treatment plant 1, the bottle 9 can be transported from one treatment device to the next, as well as within the treatment device(s), by at least one transport device 6. Shown here as treatment devices (in a sequence downstream of the direction of transport of the bottle) are an inspection apparatus 21, a filling apparatus 22 for filling the bottle 10 with a product, a closing apparatus 24, a drying apparatus 28, a labeling apparatus 30, and a packaging apparatus 32 for packaging the bottle 10.

Reference sign 2 indicates a further container inspection apparatus (for example, at the end of the line and arranged between the closing device 24 and the drying device 28) in each case, which checks, for example, the fill level in the bottle and/or the proper arrangement of the closure on the bottle 10 and/or a retaining ring and/or proper labeling and/or packaging of the bottle 10 or further production data.

Reference sign 4 denotes a sensor device in each case—here, a camera—by which—individually for each container part 9 (to be inspected)—sensor data relating to each container part 9 are collected or captured or recorded.

Reference sign 3 denotes a real-time evaluation device, by which the sensor data captured by the sensor device 4 of each container inspection apparatus 2 are evaluated in order to carry out a (predetermined and/or set) container inspection task.

In a preferred proposed method, the evaluation of this data uses a set of extracted features to assess the captured sensor data. The set of extracted features used is the result of a (trained) feature extraction by a neural network that was pre-trained with (extensive) (training) data on similar image classification (inspection) tasks. However, in the final step of evaluating the extracted features, a classical classification method is then applied.

Reference sign 50 denotes an internal server or an internal memory device, and reference sign 52 denotes an external server or an external, in particular cloud-based, memory device. For example, AI-based feature extraction can be performed on the external server 52. The set of extracted container part features obtained can preferably be deposited on the external and/or internal memory device 50/52.

Reference sign 5 denotes a memory device, which is a (fixed) component of the container inspection apparatus 2 in this case. Sensor data captured by the sensor device 4 can be deposited on this memory device 2.

Preferably, a keep strategy/image storage function is provided which can deposit images on the memory device 5 and/or in the camera 4 and/or in a read-only memory on the basis of image similarity. For example, an image of the error or required feature can be used as a reference. Using a preferably AI-based similarity metric, the similarity with respect to the reference image can be determined. Only similar images are preferably stored and saved.

Preferably, the container inspection apparatus 2 can determine a similarity variable which is characteristic of a similarity between the captured images or sensor data and predetermined and/or predeterminable reference data (such as a reference image). Depending upon the determined similarity variable, a deposit variable can be determined (for example by the container inspection apparatus), which is characteristic of whether the captured sensor data are to be deposited on the memory device 5 or not.

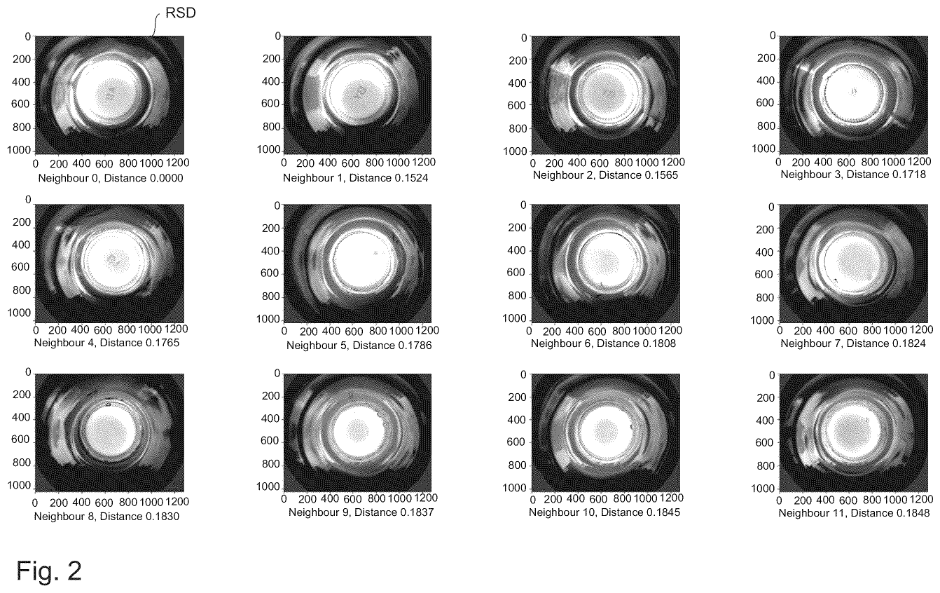

FIG. 2 shows twelve camera images to illustrate the method according to the invention according to a preferred embodiment.

In particular, these (and further camera images not shown) were used to assess similarity. FIG. 2 shows a result of the camera images sorted according to their similarity (with decreasing similarity).

These camera images are taken during a bottom inspection of a container by a camera that inspects the bottom of the container through the mouth of the container. The bottom is illuminated by a lighting device using a transmitted light method.

The first image, top-left in the figure plane of FIG. 2, which is indicated by the reference sign RSD, is used as the reference image. This therefore is at a distance of 0 from itself, determined by a distance metric (e.g., a Euclidean one).

The further camera images shown in FIG. 2 are sorted according to the distance from the reference image each time, determined on the basis of the distance metric (from left to right, then from top to bottom), and thus show an increasing distance, i.e., decreasing similarity.

The last camera image, arranged at the bottom right of the figure plane, is, compared to the other camera images shown in FIG. 2, at the highest distance with a distance of 0.1848 and is thus the eleventh neighbor of the reference image.

These camera images illustrate the high performance of the proposed method. The reference image RSD shows a container bottom with an embossing “BA.” The camera images regarded by the proposed method as most similar to this reference image, namely the 1st neighbor (“Neighbor 1”) and the 2nd neighbor (“Neighbor 2”), also show (with decreasing clarity) such an embossing “BA.” The 3rd neighbor (“Neighbor 3”) shows a drop in the middle, which also has a round shape similar to the inner contour of the “B.”

FIG. 2 shows that the proposed method of evaluating similarity using a distance metric in a feature space (wherein the feature space is spanned by features extracted in an AI-based training method), in which the images are each represented as feature vectors, can achieve that all container bottoms with the embossing “BA” can be sorted among the nearest four neighbors. If, for example, the ten most similar container bottom camera images are always deposited in the memory device, the three container bottoms with embossing “BA” present in the container stream would be deposited in this memory device and could be retrieved by the operator.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, a person skilled in the art will recognize that advantages can also result from a combination of several features shown in individual or in different FIG.

### LIST OF REFERENCE SIGNS

1 container treatment plant
2, 21 container inspection apparatus
3 real-time evaluation device
4 sensor device
5 memory device
6 transport device
10 container
9 container part
12 feature, direct printing element
14 feature, container closure
20 treatment device, in this case heating device
23 treatment device, in this case printing device
22 treatment device, in this case filling device
24 treatment device, in this case closing device
28 treatment device, in this case drying device
30 treatment device, in this case labeling device
32 treatment device, in this case packaging device
50 internal server, memory device
52 external server, memory device
RSD reference sensor data

1. A method for operating a container treatment plant for treating a plurality of container parts for containers, wherein a transport device transports the plurality of container parts as a container part stream along a predetermined transport path from at least one treatment device of the container treatment plant to at least one further treatment device of the container treatment plant, wherein at least one sensor device for carrying out a container inspection task captures sensor data relating to the container parts,
wherein
with respect to the captured sensor data, a deposit variable is determined which is characteristic of a deposit instruction for depositing the captured sensor data on a non-volatile memory device, and wherein the deposit variable is determined on the basis of a similarity variable which is characteristic of a similarity between the sensor data captured and predetermined and/or predeterminable reference data.

2. The method according to claim 1, wherein the reference data are reference sensor data captured by a sensor device.

3. The method according to claim 1, wherein the similarity variable is characteristic of a similarity between the sensor data captured and a predetermined and/or predeterminable plurality of reference sensor data.

4. The method according to claim 3, wherein the reference data are predetermined by an operator of the container treatment plant.

5. The method according to claim 1, wherein with regard to the sensor data captured, a rejection variable is determined which is characteristic of a rejection instruction for rejecting the associated container part from the container part stream, and wherein the similarity variable is determined independently of the rejection decision made.

6. The method according to claim 1, wherein sensor data captured with respect to at least one container part that has been and/or is to be rejected are used as the reference sensor data.

7. The method according to claim 1, wherein a deposit variable characteristic of a positive deposit instruction is determined if a comparatively high similarity between the sensor data captured and predetermined and/or predeterminable reference data is and/or will be determined.

8. The method according to claim 3, wherein a plurality of reference sensor data are predetermined and a deposit variable characteristic of a positive deposit instruction is determined if a comparatively low similarity between the sensor data captured and the predetermined plurality of reference sensor data is and/or will be determined.

9. The method according to claim 3, wherein the predetermined plurality of reference sensor data comprise reference sensor data relating both to container parts to be rejected from the container part stream and to container parts that are not to be rejected from the container part stream.

10. The method according to claim 1, wherein a set of container part features is predetermined and used as a basis to determine the similarity variable.

11. The method according to claim 10, wherein the set of container part features is a set of extracted container part features automatically obtained as part of a machine learning method carried out in relation to a training container inspection task.

12. The method according to claim 11, wherein the set of container part features is a set of container part features from a supervised learning method, and wherein the supervised learning method preferably is a K-nearest neighbors algorithm.

13. The method according to claim 12, wherein a feature space will be and/or is spanned by the set of extracted container part features provided, and a distance metric is and/or will be provided with respect to the feature space, and wherein the distance metric is used as a similarity measure for assessing the similarity between the captured sensor data and the reference data in order to determine the similarity variable.

14. The method according to claim 1, wherein the container inspection task is a classification task selected from a group of classification tasks which comprises classification into defective and/or defect-free container parts, detection and/or classification of types of defects in the container part, detection and/or classification of different types of container parts, detection and/or classification of a contour and/or color of the container part, detection and/or classification of the fault-free and/or faulty execution of at least one treatment step carried out on the inspected container part, and combinations thereof.

15. A container inspection apparatus for a container treatment plant for treating a plurality of container parts for containers, for carrying out a container inspection task in the container treatment plant, wherein the container treatment plant has a transport device which is configured for transporting the plurality of container parts as a container part stream along a predetermined transport path from at least one treatment device of the container treatment plant to at least one further treatment device of the container treatment plant, wherein the container inspection apparatus has at least one sensor device which is configured for capturing sensor data relating to the container parts in order to carry out the container inspection task,
wherein
the container inspection apparatus is configured for determining, with respect to the captured sensor data, a deposit variable which is characteristic of a deposit instruction for depositing the captured sensor data on a non-volatile memory device, and wherein the deposit variable is determined on the basis of a similarity variable which is characteristic of a similarity between the sensor data captured and predetermined and/or predeterminable reference data.

16. A container treatment plant for treating a plurality of container parts for containers, comprising a container inspection apparatus according to claim 15 and comprising a treatment device, at least one further treatment device, and a transport device configured for transporting the container parts from the treatment device to the at least one further treatment device.
